(19) United States
(12) Patent Application Publication
(10) Pub. No.: US 2016/0275604 A1
(43) Pub. Date: Sep. 22, 2016

(54) ADAPTIVE QUALITY ASSURANCE MANAGEMENT SYSTEM

(71) Applicant: Accenture Global Services Limited, Dublin (IE)

(72) Inventors: David C. Jones, Waxhaw, NC (US); Todd Kepler, Gastonia, NC (US); Lynn Grich, Fort Mill, SC (US); Sergio A. Salas, Charlotte, NC (US); John Fults, Charlotte, NC (US)

(21) Appl. No.: 14/660,205

(22) Filed: Mar. 17, 2015

(51) Int. Cl. G06Q 40/02

(52) U.S. Cl. CPC G06Q 40/025

(57) ABSTRACT

Information related to products, quality assurance (“QA”), and available resources is leveraged in a multi-dimensional approach to QA protocol development. The approach relies upon historical and user-defined data to tailor QA protocols to both the product at hand and the creator of the product such that necessary risk can be mitigated in a cost-effective manner. Instructions for QA protocols can be generated in a computer system and provided to one or more devices.

### FIELD

This disclosure relates to an adaptive quality assurance management system.

### BACKGROUND

Quality assurance (“QA”) practices are important for ensuring that products meet one or more quality standards. By practicing QA, mistakes and defects can be identified and corrected before products make their way to consumers. The different types of mistakes and defects and the regularities at which they occur in products can depend on multiple factors, some of which change with time. However, QA is often conducted largely on the basis of a predefined strategy incapable of adapting to these changes. Accordingly, QA may be conducted in a manner which inefficiently expends QA resources, fails to prevent mistakes and defects, or both.

### SUMMARY

In one aspect, a computer-implemented method of adaptively managing quality assurance includes accessing quality assurance information associated with quality assurance for a loan application including a plurality of different items with a plurality of corresponding annotations for each of the plurality of different items, and accessing, for each item included in the quality assurance information, data that references a risk score indicating a level of risk associated with an uncorrected error in the annotation of the given item, and a cost score indicating a quantity of one or more resources required in order to perform quality assurance processing to reduce risk of uncorrected error in the annotation of the given item. Based at least on the data that references the risk score and the cost score for each of the plurality of different items, the computer-implemented method may include selecting, by at least one processor and from among the plurality of different items, a particular subset of items included in the quality assurance information, the selection including determining that the particular subset of items need quality assurance processing and determining that the plurality of different items not included the particular subset of items do not need quality assurance processing and generating by the at least one processor and based on the particular subset of items, instructions for performing a quality assurance process on each of the particular subset of items. The at least one processor may send the instructions to one or more devices.

In some implementations, the computer-implemented method may further include determining a cumulative risk score for the loan application by summing the risk scores for every item and determining that the cumulative risk score for the loan application exceeds a risk threshold by a first differential value. Further, selecting the particular subset of items based at least on the data that references the risk score and the cost score for each of the plurality of different items may include selecting, based at least on determining that the cumulative risk score for the loan application exceeds the risk threshold, the particular subset of items.

In addition, the risk threshold may be defined by a user and determining that the cumulative risk score for the loan application exceeds the risk threshold by the first differential value may include determining that the cumulative risk score for the loan application exceeds the user-defined risk threshold by the first differential value.

In some examples, the computer-implemented method may also include determining a cumulative risk score for the particular subset of items by summing the risk scores for every item in the particular subset of items and determining that the cumulative risk score for the particular subset of items is greater than or equal to the first differential value. In these examples, selecting the particular subset of items based at least on the data that references the risk score and the cost score for each of the plurality of different items may include selecting, based at least on determining that the cumulative risk score for the particular subset of items is greater than or equal to the first differential value, the particular subset of items. The computer-implemented method may further include determining a cumulative cost score for the particular subset of items by summing the cost scores for every item in the particular subset of items, determining a quantity of items in the particular subset of items, and determining that the particular subset of items has one or more of a minimal cumulative cost score and a minimal quantity of items relative to other subsets of items. In these instances, selecting the particular subset of items based at least on the data that references the risk score and the cost score for each of the plurality of different items may include selecting, based at least on determining that the particular subset of items has one or more of a minimal cumulative cost score and a minimal quantity of items relative to other subsets of items, the particular subset of items.

In some implementations, the risk score for each item may be based at least on a level of creator occurrence associated with error in the annotations of the given items and the level of creator occurrence references a historical rate of error in the annotation of the given item for a particular creator of the annotations. Selecting the particular subset of items based at least on the data that references the risk score and the cost score for each of the plurality of different items may include selecting, based at least on the particular creator's historical rate of error in the annotation of the given item of the loan application, the particular subset of items. In these implementations, the risk score for each item may be further based on one or more of a general level of occurrence for creators across a plurality of loan applications, a level of severity, and a level of detectability associated with uncorrected error in the annotation of the given item. Selecting the particular subset of items based at least on the data that references the risk score and the cost score for each of the plurality of different items may include selecting, based at least on one or more of the general level of occurrence for creators across the plurality of loan applications, the level of severity, and the level of detectability associated with uncorrected error in the annotation of the each item of the loan application, the particular subset of items. In addition, the level of detectability associated with uncorrected error in the annotation of the given item on which the risk score for each item is based, may be reflective of a degree of difficulty in discovering error in the annotation of the given item at a point downstream from the quality assurance process and the risk score for each item may be based on the level of detectability associated with uncorrected error in the annotation of the given item.

In some examples, the one or more resources required in order to perform the quality assurance processing to reduce risk of uncorrected error in the annotation of the given item may include one or more of a quantity of time, a quantity of funds, and a quantity of quality assurance agents.

In some implementations, the computer-implemented method may also include evaluating, for each of a plurality of different subsets of items, at least the risk score and cost score for each item in the given subset of items. In these implementations, selecting the particular subset of items based at least on the data that references the risk score and the cost score for each of the plurality of different items may include selecting, based at least on evaluation results, the particular subset of items from among the plurality of different subsets of items.

In some examples, a failure mode and effects analysis which includes determining a risk priority number for each item of the loan application may be performed before accessing the risk score and cost score. In addition, the risk score for each item of the loan application may be based at least on its corresponding risk priority number. In these examples, accessing, for each item of the loan application, data that references the risk score indicating the level of risk associated with uncorrected error in the annotation of the given item may include accessing, for each item of the loan application, data that references the risk score based on the corresponding risk priority number of the given item and indicating the level of risk associated with uncorrected error in the annotation of the given item.

In some implementations, the loan application may be associated with a particular creator from among a plurality of creators, the particular creator being responsible for annotating each item of the loan application. In these implementations, selecting the particular subset of items based at least on the data that references the risk score and the cost score for each of the plurality of different items may include selecting, based at least on the particular creator associated with the loan application, the particular subset of items.

In some examples, the one or more devices may include one or more quality assurance agents configured to perform the quality assurance process on the loan application according to the instructions. In addition, performing the quality assurance process on the loan application may include performing, for each item in the particular subset of items, the quality assurance processing to reduce risk of uncorrected error in the annotation of the given item. In some of these examples, the computer-implemented method may further include receiving data that references results of the quality assurance process and updating the data that references the risk score and the data that references the cost score based on the results of the quality assurance process.

In some implementations, the quality assurance information associated with quality assurance for the loan application including the plurality of different items with the plurality of corresponding annotations for each of the plurality of different items, may include creator information indicating the creator responsible for annotating each item of the loan application and information that references an item type for each item of the loan application. Furthermore, accessing, for each item of the loan application, data that references the risk score and cost score may include retrieving, based on the creator information and the information that references the item type for each item of the loan application, data that references the risk score and cost score for each item of the loan application.

In some examples, the computer-implemented method also includes determining a cumulative cost score for the particular subset of items by summing the cost scores for every loan application item in the particular subset of items and determining that the cumulative cost score for the particular subset of items is less than or equal to a cost threshold indicating a quantity of one or more resources allocated by a user for performing the quality assurance process on the loan application. In these examples, selecting the particular subset of items based at least on the data that references the risk score and the cost score for each of the plurality of different items may include selecting, based at least on determining that the cumulative cost score for the particular subset of items is less than or equal to the cost threshold indicating the quantity of one or more resources allocated by the user for performing the quality assurance process on the loan application, the particular subset of items.

In another aspect, an adaptive quality assurance management system includes at least one processor and at least one memory coupled to the at least one processor having stored thereon instructions which, when executed by the at least one processor, causes the at least one processor to perform operations. The operations may include accessing quality assurance information associated with quality assurance for a loan application including a plurality of different items with a plurality of corresponding annotations for each of the plurality of different items, and accessing, for each item included in the quality assurance information, data that references a risk score indicating a level of risk associated with an uncorrected error in the annotation of the given item, and a cost score indicating a quantity of one or more resources required in order to perform quality assurance processing to reduce risk of uncorrected error in the annotation of the given item. Based at least on the data that references the risk score and the cost score for each of the plurality of different items, the operations may include selecting from among the plurality of different items, a particular subset of items included in the quality assurance information, the selection including determining that the particular subset of items need quality assurance processing and determining that the plurality of different items not included the particular subset of items do not need quality assurance processing and generating, based on the particular subset of items, instructions for performing a quality assurance process on each of the particular subset of items. The instructions may be sent to one or more devices.

In yet another aspect, at least one computer-readable storage medium is encoded with executable instructions that, when executed by at least one processor, cause the at least one processor to perform operations. The operations may include accessing quality assurance information associated with quality assurance for a loan application including a plurality of different items with a plurality of corresponding annotations for each of the plurality of different items, and accessing, for each item included in the quality assurance information, data that references a risk score indicating a level of risk associated with an uncorrected error in the annotation of the given item, and a cost score indicating a quantity of one or more resources required in order to perform quality assurance processing to reduce risk of uncorrected error in the annotation of the given item. Based at least on the data that references the risk score and the cost score for each of the plurality of different items, the operations may include selecting from among the plurality of different items, a particular subset of items included in the quality assurance information, the selection including determining that the particular subset of items need quality assurance processing and determining that the plurality of different items not included the particular subset of items do not need quality assurance processing and generating, based on the particular subset of items, instructions for performing a quality assurance process on each of the particular subset of items. The instructions may be sent to one or more devices.

The details of one or more implementations are set forth in the accompanying drawings and description, below. Other potential features and advantages of the disclosure will be apparent from the description and drawings, and from the claims.

### BRIEF DESCRIPTION OF THE DRAWINGS

FIGS. 1, 2, 4, 5, 9, 11, and 12 are diagrams of exemplary systems.

FIGS. 3, 6A, and 6B are flowcharts of exemplary processes.

FIGS. 7, 8A, 8B, and 10 are diagrams illustrating data associated with exemplary processes.

### DETAILED DESCRIPTION

In some implementations, a multi-dimensional approach leverages information related to products, quality assurance (“QA”), and available resources to develop QA protocols in a manner which mitigates necessary risk and limits associated costs. The approach relies upon historical and user-defined data to tailor QA protocols to both the product at hand and the creator of the product.

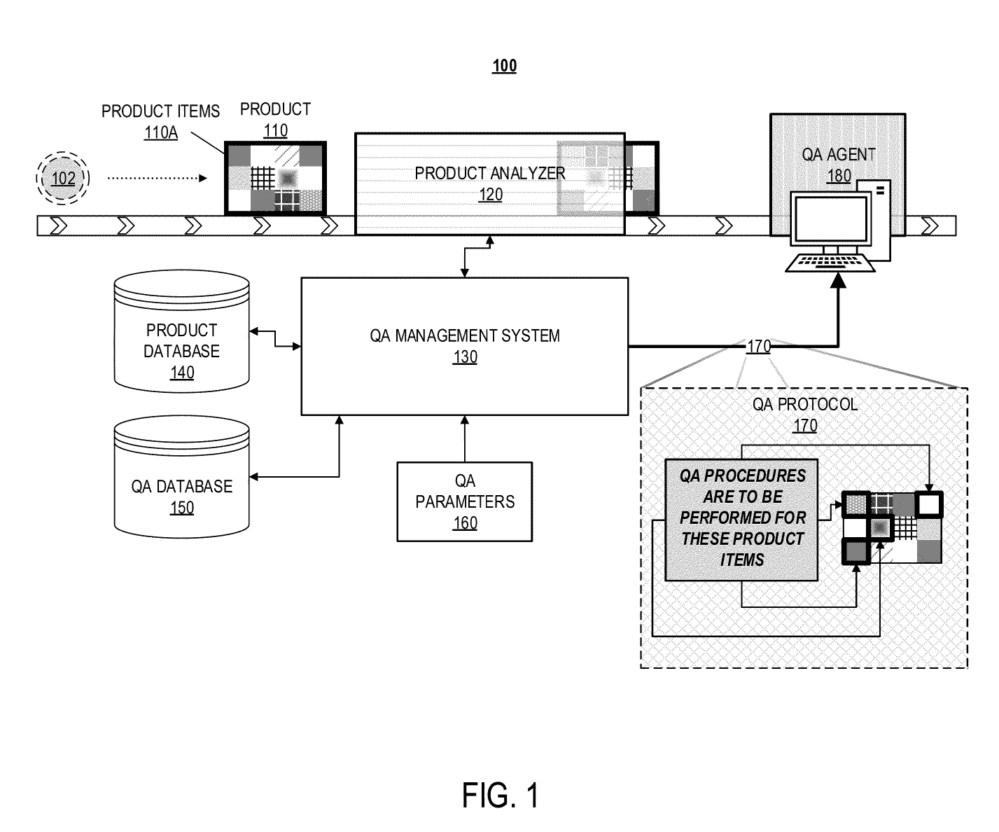

FIG. 1 illustrates an example system 100 in which a QA protocol 170 for product 110 can be determined by QA management system 130 and provided to a QA agent 180. The system 100 includes a product 110, including a plurality of different product items 110A, which may have been created by an upstream source 102. For example, product 110 may be a document populated with text. In this example, the plurality of product items 110A may be a plurality of different text entry fields populated by way of user input 102 provided by a user (e.g., author). Following creation and completion by the upstream source 102, the product 110 may be evaluated by QA management system 130 to determine which, if any, of the product items 110A of product 110 need QA processing. The QA management system 130 may also determine which, if any, of the product items 110A of product 110 do not need QA processing. The QA management system 130 may then develop QA protocol 170 including instructions for performing QA processing on the determined subset of product items. The QA agent 180 may then be provided with the QA protocol 170 so that it may be able to perform QA processing for the product 110 according to the instructions included in the QA protocol 170. In the example described above, QA agent 180 could be an editor, with the QA protocol 170 instructing the editor 180 to proofread certain text fields for typographical or substantive errors and make any necessary corrections.

In operation, the QA management system 130 may access QA information associated with the product 110 which may be made available by a product analyzer 120. The product analyzer 120 may monitor a flow of products making their way from one or more upstream sources 102 to one or more destinations. As depicted in FIG. 1, the flow of products monitored by product analyzer 120 may include the product 110. The product analyzer 120 may determine information such as which types of product items 110A are included in the product 110 and an identity of the upstream source responsible for creating the product 110. The product analyzer 120 may then make this information available, as quality assurance information, to the QA management system 130.

Products, such as product 110 and its product items 110A, can be products or results of any type of process performed by one or more upstream sources. That is, each product may be a result of one or more processes performed by upstream sources and may be tangible or non-tangible in form. For example, product 110 may be a physical document or an electronic document. Product items, such as product items 110A, may be any component or subcomponent of its corresponding product. In other words, product items (or more simply “items”) are the building blocks of each product. A process by one or more upstream sources 102 may be a step taken to construct, design, evaluate, manufacture, assemble, synthesize, develop, formulate, draft, prepare, or revise such a product.

In some implementations, the process performed by one or more upstream sources 102 involves one or more of creating, modifying, and assembling the items of the product. In some implementations, system 100 includes a plurality of upstream sources 102 which each in turn provide a plurality of products. In the example discussed above, the plurality of upstream sources 102 could include user input provided by a plurality of different authors of a publishing organization. Upstream sources 102 may be electronic, electro-mechanical, user input provided by people, or a combination thereof. Accordingly, the channel by which product 110 may be passed from upstream source 102 to QA agent 180, as depicted in FIG. 1, may be physical or electronic. For example, one or more of the channels in system 100 may be communication channels of a network.

In some implementations, the product provided by one or more upstream sources 102 may be subject to additional and analogous processes performed downstream by one or more other parties. The one or more destinations may include the one or more parties which may, for example, perform additional processing on each product or utilize the product as a consumer or end-user. In the example described above, such additional processing could include formatting document 110 into a publication. The quality assurance information accessed by QA management system 130 may include detailed product information regarding the each product and its origin. In the example, this could include information indicating the types of text entry fields included in document 110, subject matter, and an identity of the author. In some implementations, the QA management system 130 receives less detailed product information regarding each product and its origin and instead proceeds to look-up the remaining product details from one or more of product database 140 and QA database 150 using the less detailed information.

Once the quality assurance information has been made available by the product analyzer 120, the QA management system 130 may access the quality assurance information. The QA management system 130 may use the quality assurance information to determine QA protocol 170 for the product 110. For example, the QA management system 130 may use information identifying the types of product items 110A included in product 110 and the upstream source responsible for creating the product 110 to retrieve additional information from product database 140 and QA database 150. In some implementations, the QA management system 130 queries the product database 140 and QA database 150 for the additional information related to the accessed quality assurance information. The additional information may include data that references a risk score for each of the product items 110A included in product 110. The data that references the risk score may indicate a level of risk associated with an uncorrected error in the given item. The additional information may also include data that references a cost score for each of the product items 110A included in product 110. The data the references the cost score may indicate a quantity of one or more resources required in order to perform a procedure to address error in the given item. For example, the data the references the cost score may indicate one or more of a quantity of time, funds, or QA agents required to perform QA processing for the given product item. In the example described above, the cost score for each populated text field might indicate an expected number of minutes that it would take for an editor to proofread and potentially fix an error in the text field. The additional information may be based on historical QA results for each given item. In some implementations, the QA management system may be provided with a product type identifier by the product analyzer 120, which it may use to retrieve a corresponding list of product items associated with the product type identifier from the product database 140. The QA management system may then, for instance, access at least a portion of the additional information, as described above, by querying the QA database 150 for information corresponding to one or more of each item and the creator.

Together, data referencing the risk score and cost score for each given item can be utilized by the QA management system 130 to conduct a cost-benefit analysis on each given product item 110A. That is, based on the data referencing the risk score and cost score, the QA management system 130 may be able to determine an amount of risk that may be mitigated by performing QA on a given product item and the expenses incurred by doing so. In order to initially determine whether any QA is necessary, the QA management system 130 may determine a cumulative risk score for the product 110. The cumulative risk score for product 110, or sum of the risk scores for each of the product items 110A, may indicate a total amount of risk presented by product 110. In the example described above, the cumulative risk score 130 may indicate an amount of risk the document 110 presents to the publishing organization. QA parameters 160, which may be accessed by QA management system 130, may indicate a risk tolerance threshold for each product. The risk tolerance threshold may, for example, be a user-defined value that indicates a maximum cumulative risk score that the user tolerates for the product. In some implementations, the risk tolerance threshold is a constant value for all creators. In the example described above, this could be an amount of risk that the publishing organization is comfortable accepting. In implementations with multiple different types of products, risk tolerance thresholds may be specific to each type of product. In these implementations, the QA management system 130 may retrieve QA parameters in a same manner as described above in reference to product item list retrieval.

The QA management system 130 may compare the cumulative risk score for the product 110 to the risk tolerance threshold to determine whether the product 110 needs QA processing. If the QA management system 130 determines that the cumulative risk score for the product 110 exceeds the risk tolerance threshold, then QA management system 130 may further select a subset of product items 110A for QA processing. By subjecting a subset of product items 110A to QA processing, the risk that they respectively contribute to the cumulative risk score for the product can be mitigated. In some examples, the subset of product items 110A may serve to mitigate an amount of risk (e.g., remove) such that a cumulative risk score for the items not included in the subset falls below the risk tolerance threshold. The QA management system 130 may access one or more additional QA parameters 160 in determining which particular subset of product items 110A need QA processing. In some examples, the QA management system 130 uses one or more optimization processes in selecting the particular subset of product items 110A for QA processing. Upon determining whether the product 110 needs QA processing, and if so, which particular subset of product items 110A require QA processing, the QA management system 130 generates QA protocol 170 including instructions for performing QA processing on the determined subset of product items. The QA agent 180 may then be provided with the instructions of the QA protocol 170 so that it may be able to perform QA processing for the product 110 accordingly. QA processing may include determining if each item has an error, and, if so, correcting the error.

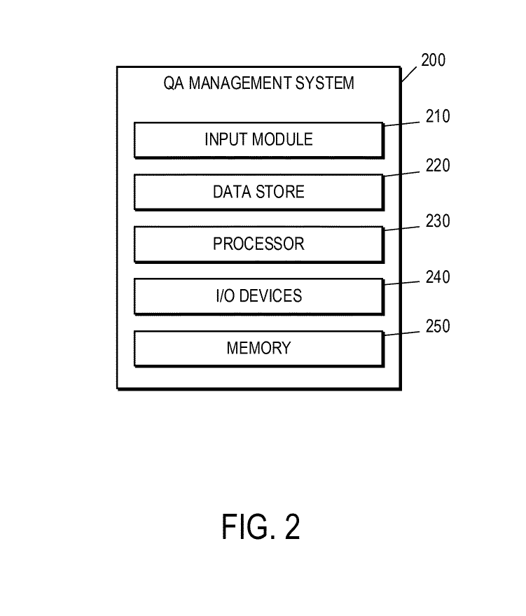

FIG. 2 illustrates an exemplary task assignment system 200 for determining task assignments. The system 200 includes an input module 210, a data store 220, one or more processors 230, one or more I/O (Input/Output) devices 240, and memory 250. The input module 220 may be used to input any type of information accepted by a QA management process leveraged by the system 200. For example, the input module 210 may be used to receive, for example, QA information, product information, data that references the risk score for each product item, data that references the cost score for each product item, a cumulative risk score for the product, QA parameters, and a risk tolerance threshold. In some implementations, data from the input module 210 is stored in the data store 220. The data included in the data store 220 may include, for example, QA information, product information, data that references the risk score for each product item, data that references the cost score for each product item, a cumulative risk score for the product, QA parameters, risk tolerance threshold, QA protocols, and all other data described above in reference to FIG. 1.

In some examples, the data store 220 may be a relational database that logically organizes data into a series of database tables. Each database table in the data store 220 may arrange data in a series of columns (where each column represents an attribute of the data stored in the database) and rows (where each row represents attribute values). In some implementations, the data store 220 may be an object-oriented database that logically or physically organizes data into a series of objects. Each object may be associated with a series of attribute values. In some examples, the data store 220 may be a type of database management system that is not necessarily a relational or object-oriented database. For example, a series of XML (Extensible Mark-up Language) files or documents may be used, where each XML file or document includes attributes and attribute values. Data included in the data store 220 may be identified by a unique identifier such that data related to a particular process may be retrieved from the data store 220.

The processor 230 may be a processor suitable for the execution of a computer program such as a general or special purpose microprocessor, and any one or more processors of any kind of digital computer. In some implementations, the system 200 includes more than one processor 230. The processor 230 may receive instructions and data from the memory 250. The memory 250 may store instructions and data corresponding to any or all of the components of the system 200. The memory 250 may include read-only memory, random-access memory, or both.

The I/O devices 240 are configured to provide input to and output from the system 200. For example, the I/O devices 240 may include a mouse, a keyboard, a stylus, or any other device that allows the input of data. The I/O devices 240 may also include a display, a printer, or any other device that outputs data.

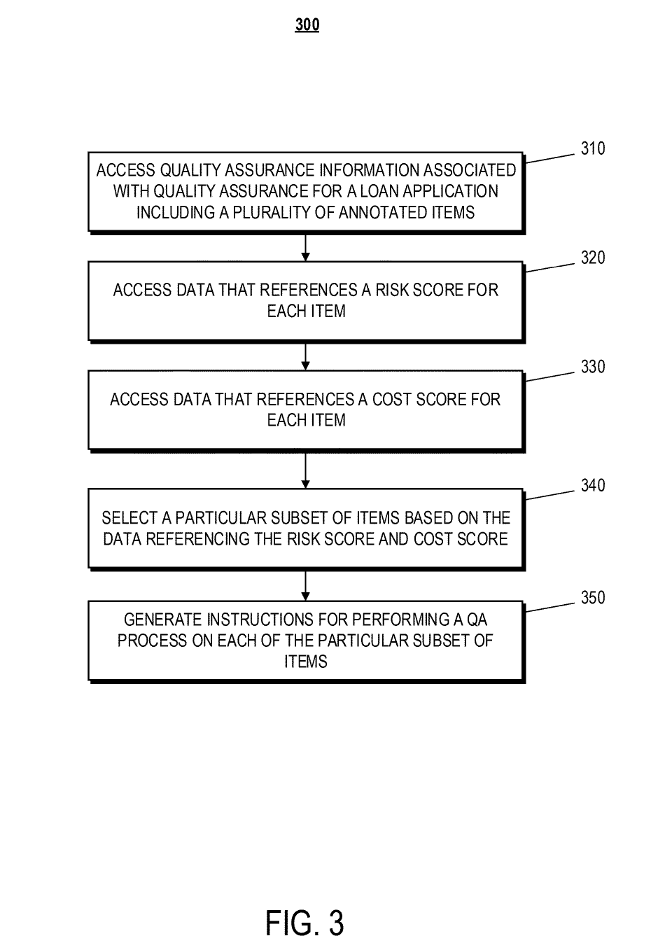

FIG. 3 illustrates an example process 300 for managing QA for a product. The operations of process 300 are described generally as being performed by system 200. In some implementations, operations of the process 300 may be performed by one or more processors included in one or more electronic devices.

The system 200 accesses quality assurance information associated with quality assurance for a product including a plurality of product items (310). In this example, the product comprises a loan application and the plurality of product items comprise a plurality of annotated items on the loan application. For example, the loan application may be a checklist completed by a loan processor, with each annotated item being a checklist item answered by the loan processor. In this example, the loan processor is the creator of the product. The quality assurance information may include information identifying the types of product items (e.g., the different checklist items) and the creator of the product (e.g., the loan processor). In some implementations, the quality assurance information may be made available to the system 200 by a product analyzer, for example.

The system 200 accesses data that references a risk score for each product item (320). For example, each product item may include an annotated checklist item. In this example, the data that references a risk score for each product item includes data that references a risk score for each annotated item of the checklist. As previously described, the data the references the risk score may indicate a level of risk associated with an uncorrected error in the given annotated item. In some implementations, the risk score may include a risk priority number for each item. In these implementations, the risk priority number may be determined by way of a failure mode and effects analysis (“FMEA”). Steps of an FMEA may include determining (i) various potential modes of error, (ii) determining potential causes of error, and (iii) determining potential consequences of each error. The FMEA may be conducted on an ongoing basis (e.g., in real-time). In some instances, the risk score may be based on one or more of occurrence information, severity information, and detectability information associated with each item. In some implementations, the occurrence information includes an occurrence value, the severity information includes a severity value, and the detectability information includes a detectability value. Severity information may indicate a level of detriment yielded by an error in each given item. The level, for example, may be indicated by the severity value with respect to a severity scale or range. Occurrence information may indicate how frequently errors associated with each item occur. The occurrence value may be an error rate determined on the basis of historical QA results on each item (e.g., percentage of instances that an error is present in the item, as discovered through previous QA processes). Detectability information may indicate a level of difficulty associated with discovering an error in each item or how likely it is that an error with the item is caught prior to it reaching an end-user. The detectability value may be user-defined, based on downstream feedback information, or both and determined on the basis of comparing data from one or more QA agents with downstream data. In some instances, the risk score is the product of occurrence value, severity value, and detectability value associated with each item, determined through a multiplication operation.

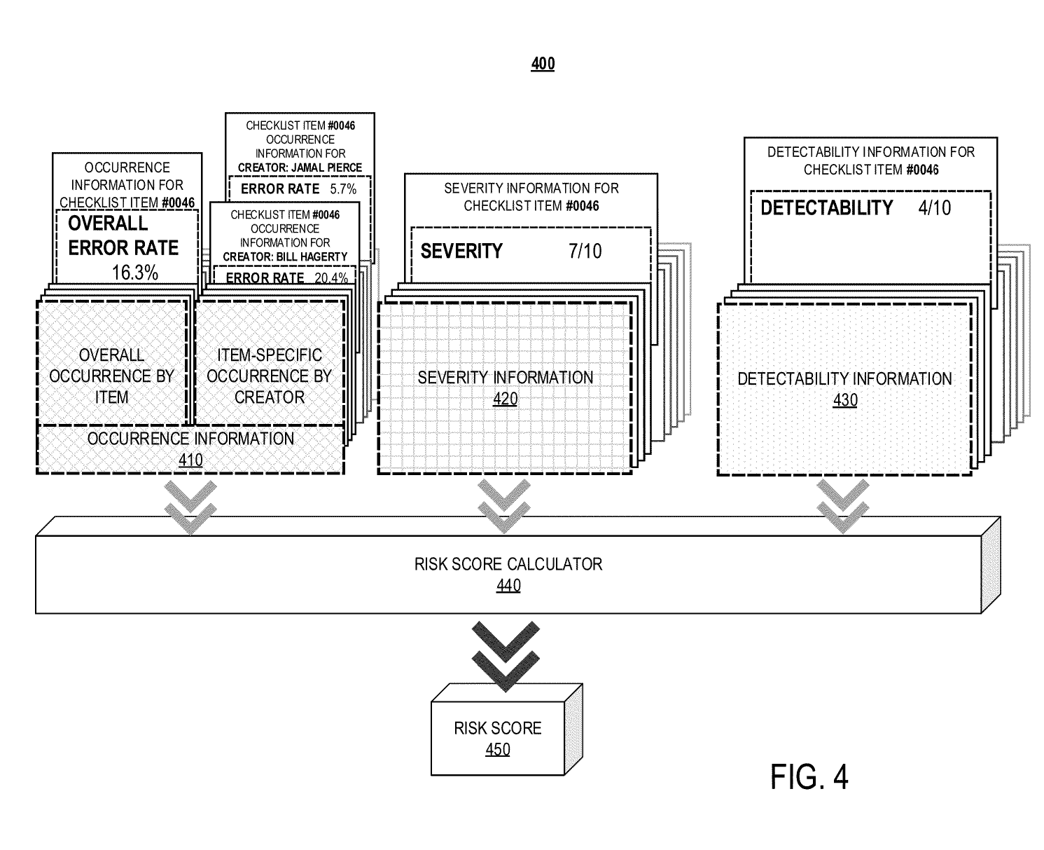

FIG. 4 illustrates a diagram for an exemplary system 400 which calculates a risk score on the basis of occurrence information, severity information, and detectability information as described above. Specifically, the system 400 includes a risk score calculator 440 which determines a risk score 450 for each item based on occurrence information 410, severity information 420, and detectability information 430. In some implementations, the risk score 450 is stored in a product database or QA database, such as those described above in association with FIGS. 1-3. In some implementations the occurrence information 410, severity information 420, and detectability information 430 are stored in a product database or QA database, such as those described above in association with FIGS. 1-3, and the risk score 450 is determined by a risk score calculator 440 included in a QA management system, such as that described above in association with FIGS. 1-3. Regardless, the QA management system may obtain the risk score for each item and operate to update all associated data.

Occurrence information 410 may indicate how frequently errors associated with each item occur. In the loan application example, an error might be an incorrect answer/annotation provided for a checklist item by the loan processor. This error rate may be determined on the basis of historical QA results on each item (e.g., percentage of instances that an error is present in the item, as discovered through previous QA processes). Historical QA results may include one or more of an overall error rate (e.g., how often this item has historically included an error) and a creator error rate (e.g., how often the specific creator/loan processor responsible for annotating the item has historically included an error in this item). In this manner, the occurrence information may change as a function of time as well as creator, which in turn allows the QA management system to adapt QA processes with each creator's performance. For example, when determining the risk score 450 for checklist item #0046 from a checklist created by a loan processor by the name of Jamal Pierce, the risk score calculator 440 may look-up or determine an overall error rate that indicates how often checklist item #0046 (e.g., 16.3%) has contained an error (e.g., for all creators) as well as an creator error rate that indicates how often checklist item #0046 has contained an error when Jamal Pierce was its creator (e.g., 5.7%). In this example, the occurrence information 410 may indicate the 16.3% overall error rate and the 5.7% error rate for Jamal Pierce. In some implementations, the occurrence value utilized by risk calculator 440 may be an average of the overall error rate and the creator error rate. For the example discussed, the occurrence value for the consideration of (i) checklist item #0046, and (ii) Jamal Pierce could be 11% (e.g., average error rate). That is, the risk score for a given item can be expected to decrease over time for creators that consistently meet quality standards.

Severity information 420 may indicate a level of detriment yielded by an error in each given item. This information may be user-defined, based on downstream feedback information, or both. For instance, severity information 420 may serve to indicate how much harm could be caused by such an error. The level, for example, may be indicated by a severity value with respect to a severity scale or range. The severity information 420 is likely to vary from item-to-item, as errors in some items may be considered “tolerable” by a user, while others are “unacceptable”. In the loan application example, an error in an annotation of a checklist item associated with a loan applicant's annual income be more problematic than an error in an annotation of a checklist item associated with a loan applicant's fax number, for example. In this instance, the latter item may have a low severity score relative to that of the former item.

Detectability information 430 may indicate a level of difficulty associated with discovering an error in each item. That is, detectability information 430 may serve to indicate how likely it is that an error with the item is caught prior to it reaching an end-user. This information may be determined on the basis of comparing data from one or more QA agents with downstream data. For example, if it is regularly determined in a post-QA stage that the one or more QA agents did not catch an error in a particular item, the detectability information 430 may reflect a high level of difficulty associated with discovering error in the particular item. This information may be user-defined, based on downstream feedback information, or both.

Referring again to FIG. 3, the system 200 accesses data that references a risk score for each item (320), such as one or more of occurrence information 410, severity information 420, detectability information 430, and risk score 450. The system 200 accesses data that references a cost score for each item (330). As described above, the data the references the cost score may indicate a quantity of one or more resources (e.g., time, funds, or QA agents) required in order to perform a procedure to address error in the given item. This information may be user-defined, based on downstream feedback information, or both. In some implementations, the cost score is stored in a product database or QA database as described above in association with FIGS. 1-2. In some implementations a QA management system, such as that described above in association with FIGS. 1-2, may determine the cost score based on the quantity of one or more resources historically required to perform QA processing on the given item.

Using the data that references the risk score, the data that references the cost score, and one or more QA parameters, the system 200 may select a particular subset of items (340), the selection including determining that the particular subset of items need QA processing and determining that the plurality of different items not included in the particular subset of items do not need QA processing. The system 200 may then generate instructions for performing a QA process on each of the particular subset of items (350). These instructions may be provided to one or more devices, such as automated QA agents, or client devices associated with QA agent personnel or users. Upon receipt of instruction, QA agents may then perform a QA process on the particular subset of items. In some implementations, the instructions are provided as a report which can be distributed to QA agents or further evaluated.

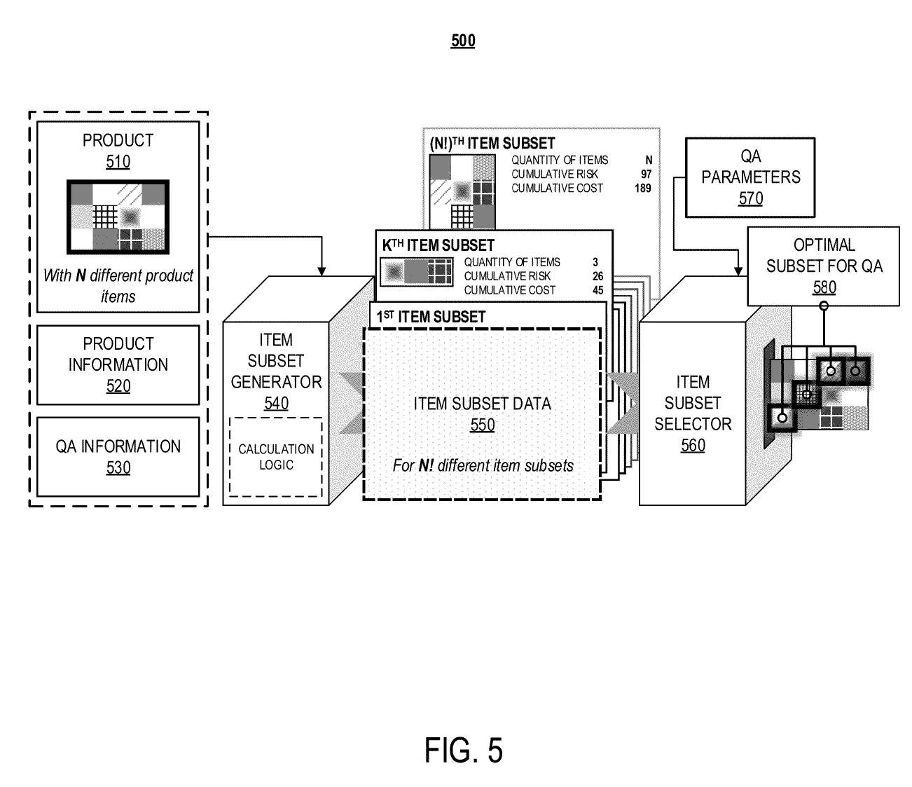

FIG. 5 illustrates an exemplary system 500 which selects a particular subset of product items on the basis of product information and QA information. System 500 includes an item subset generator 540 and an item subset selector 560, which may be included in a QA management system as described above in association with FIGS. 1-4.

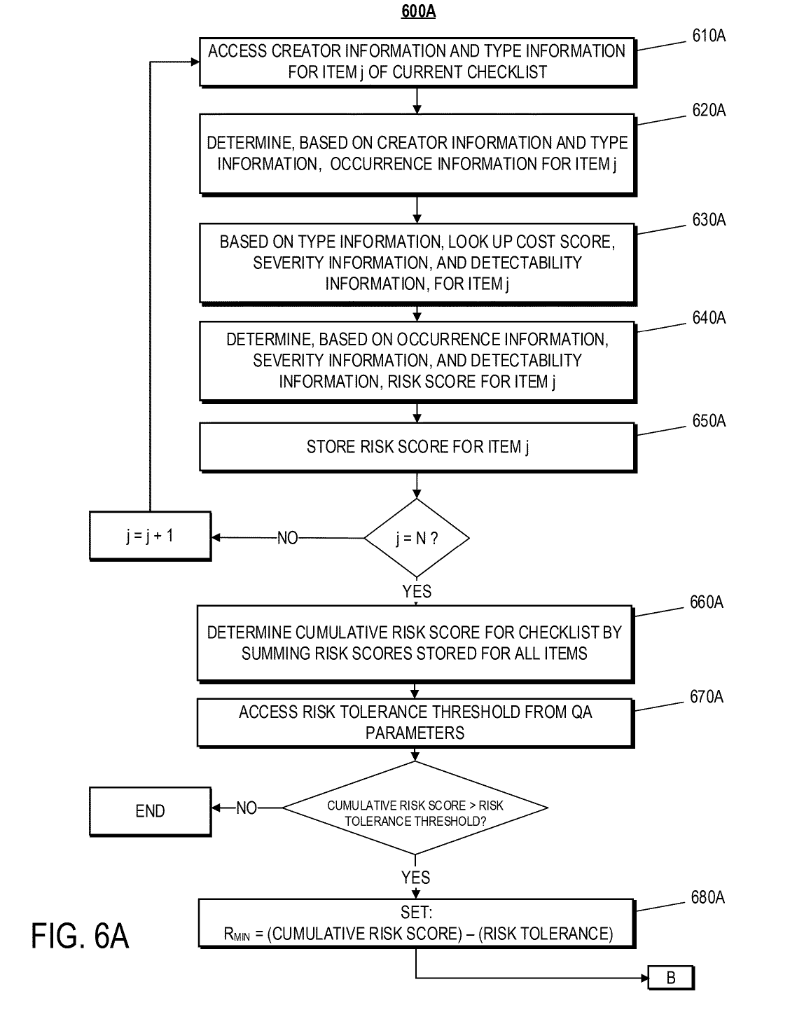

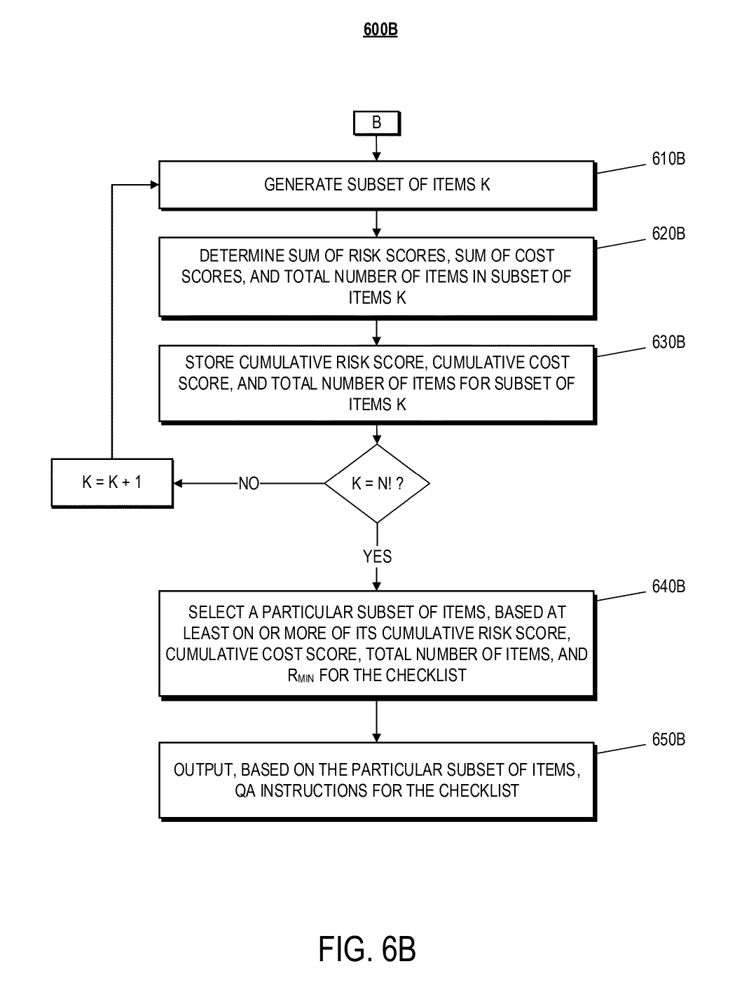

FIGS. 6A-6B illustrates an exemplary processes 600A and 600B for managing QA for a product. The operations of process 600A-B is described generally as being performed by systems 100, 200, and 500. In some implementations, operations of the process 600A-B may be performed by one or more processors included in one or more electronic devices.

The system 500 accesses creator information and type information for an item “j” of a current checklist (610A). For example, a value “j” may be initialized such that system 500 begins (e.g., at 610A of a first iteration) at a first item of the checklist. As described above, this QA information may be made available by a product analyzer, product database, or QA database. In some implementations, an item subset generator 540 may receive this information. The system 500 may determine, based on the creator information and type information, occurrence information for item j (620A). The system 500 may also look-up, on the basis of type information, a cost score for item j, as well as severity information and detectability information for item j (630A). A risk score for item j is then determined based on occurrence information, severity information, and detectability information (640A). In some implementations, the risk score is determined based on occurrence information, severity information, and detectability information as described above in reference in FIGS. 3-4. System 500 may then store the risk score for item j (650A). After storing the risk score for item j, the value of j is incremented and the process 610A-650A may be repeated until all items of the product (e.g., checklist) have been considered by system 500 (e.g., when j is equal to N or the number of items in the product). As described above, process 610A-650A may be performed by a QA management system, such as that described in association with FIGS. 1-4. In some implementations, process 610A-610B may be performed by item subset generator 540 as enabled by calculation logic.

At 660A, the system 500 determines a cumulative risk score for the product (e.g., checklist) by summing all of the risk scores stored (660A). As previously described, this cumulative risk score may be compared to a predefined risk tolerance threshold (670A-680A). As described above, the risk tolerance threshold may, for example, be a user-defined value that indicates a maximum cumulative risk score that the user tolerates for the product. If system 500 determines that the cumulative risk score is less than the predefined risk tolerance threshold, then the process may end. That is, the system determines that the level of risk associated with forgoing QA processing on the product (e.g., checklist) is tolerable to the user. If, however, the system 500 determines that the cumulative risk score is greater than the predefined risk tolerance threshold, then the system 500 may initialize a value “R_{MIN}” to a value equal to the cumulative risk score minus the risk tolerance threshold value. In other words, R_{MIN} is the quantity by which the cumulative risk score of the product exceeds the risk tolerance threshold. That is, R_{MIN} is the amount of risk that system 500 seeks to mitigate/remove by requiring a particular subset of items to undergo QA processing. In implementations where the risk tolerance threshold is constant, R_{MIN} will likely vary from creator-to-creator. This is because the risk score for each item may depend on occurrence information, which may take each creator's own error rate into account; a value that can be unique to the creator. In this manner the QA processing adapts to the performance of each creator, which may help to conserve resources and mitigate error.

The system 500 may then proceed to process 600B to select the particular subset of items. At 600B, the system 500 generates a subset of items “K”. For example, a value “K” may be initialized such that system 500 begins (e.g., at 610B of a first iteration) at possible subset of items. For subset of items K, the system 500 determines a sum of risk scores, sum of cost scores, and total number of items in the subset (620B). At 630B, the system 500 stores the cumulative risk score, cumulative cost score, and total number of items for subset of items K. After 630B, the value of K is incremented and the process 610B-630B may be repeated until every possible permutation of subsets of items in the product (e.g., checklist) has been considered by system 500. That is, if the product being analyzed by system 500 contains N different product items, then system 500 may generate up to N! (i.e., factorial of N) different subsets of items. Exemplary subset data generated by system 500 through recursive process 610B-630B is depicted as item subset data 550 in FIG. 5. In some implementations, the system 500 a limited quantity of subsets of items as dictated by one or more QA parameters. For example, system 500 may determine prior to subset generation that a portion of possible subsets are ineligible for selection and will thus avoid generating the portion.

At 640B, the system 500 may select a particular subset of items based at least on one or more of its cumulative risk score, cumulative cost score, total number of items, and R_{MIN} for the product (640B). As described above, the particular subset of items may be selected on the basis of one or more optimization processes. For instance, one or more optimization processes may operate to allow system 500 to select a particular subset, from among all of the generated subsets, with one or more of an optimal cumulative risk score, optimal cumulative cost score, and optimal total number of items included. In some implementations, the particular subset of items may be selected based at least in part on comparing its cumulative risk score to R_{MIN} for the product. That is, the particular subset of items may be selected based at least in part on it mitigating enough risk (e.g., R_{MIN}) such that satisfied cumulative risk score for the items not included in the particular subset may be less than the risk tolerance threshold. The particular subset of items may also be selected on basis of a minimization function applied to one or more or the cumulative cost score and the total number of items. Following selecting the particular subset of items, system 500 may generate and output instructions for performing QA processing on the particular subset of items. As described above, process 640B-650B may be performed by a QA management system, such as that described in association with FIGS. 1-4. In some implementations, process 640B-650B may be performed by item subset selector 560.

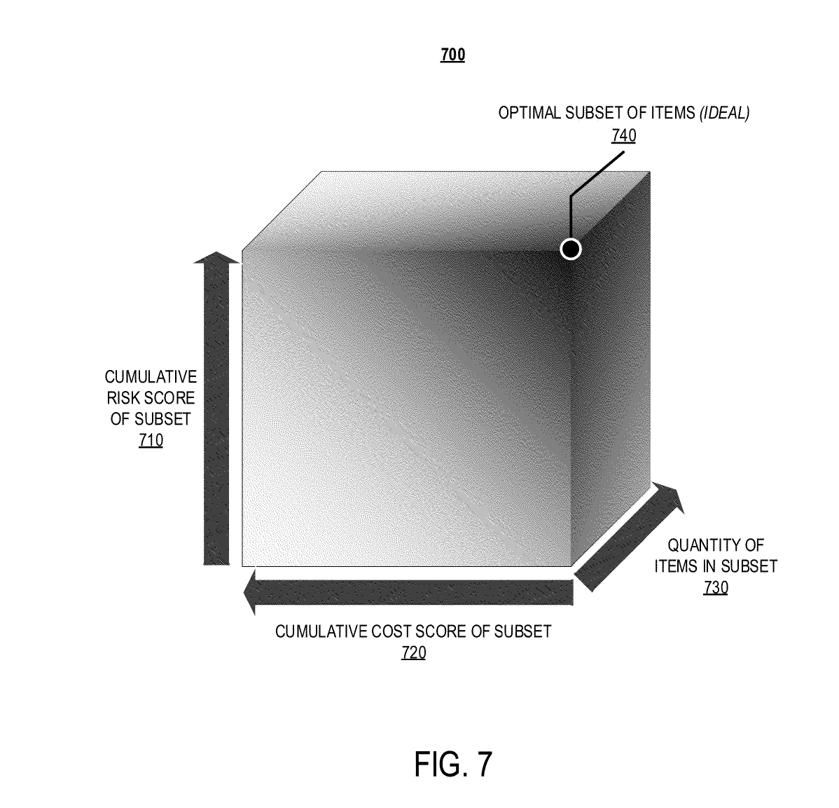

FIG. 7 illustrates an exemplary diagram 700 which demonstrates one or more objectives of optimization processes performed in association with FIGS. 1-6 above. More specifically, diagram 700 depicts a three-dimensional space within which each generated subset of items may be represented by coordinates corresponding to the cumulative cost score of the subset 720, the cumulative risk score of the subset 710, and the quantity of items in the subset 730. Diagram 700 serves only as an aid by which a subset selection process conducted on the basis of characteristics 710-720 may be visualized. Accordingly, it can be seen that an optimal subset of items 740 may be a subset of items with a maximal cumulative risk score (e.g., so as to mitigate the most amount of error by performing QA), minimal cost score (e.g., so as to conserve resources), and minimal quantity of items (e.g., so as to prioritize the QA processing of certain items). In some implementations, objectives of one or more optimization processes associated with subset selection are ones which seek to select a subset of items most closely positioned to optimal subset of items 140.

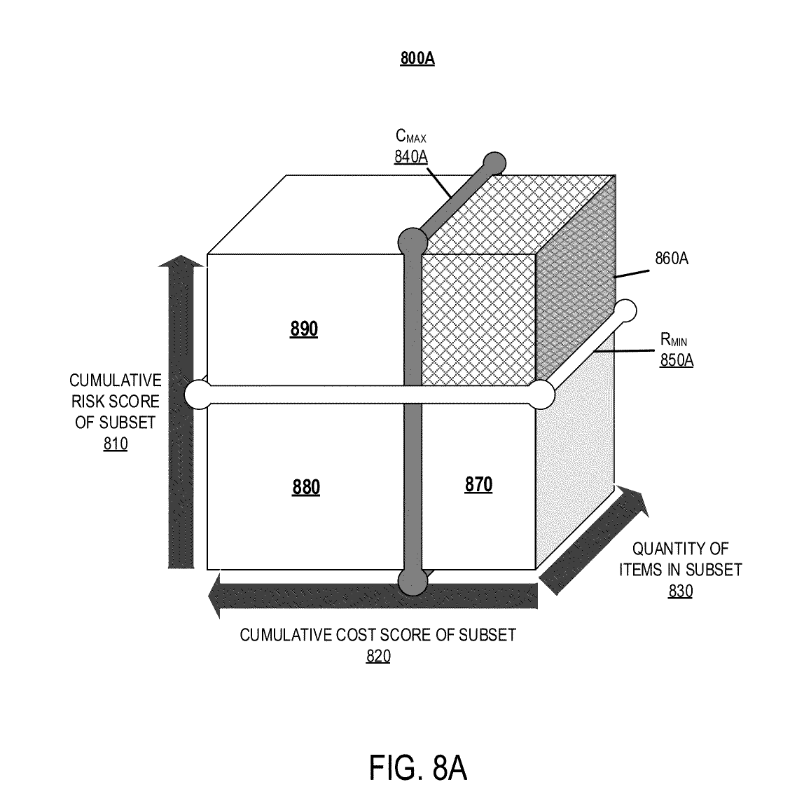

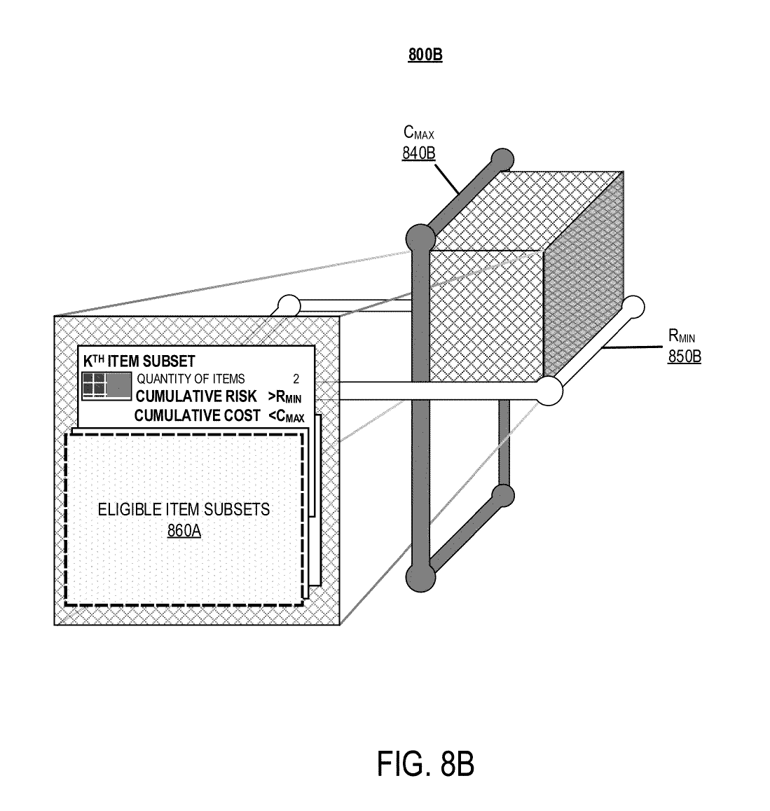

FIG. 8A illustrates an exemplary diagram 800A which demonstrates one or more objectives of optimization processes performed in association with FIGS. 1-7 above. Diagram 800A is a visual aid similar to that which has been described in reference to FIG. 7. In some implementations, one or more thresholds, such as 840A and 850A, may be used in selecting the particular subset of items. For example, QA parameters (e.g., such as those described above) may include a maximum cumulative cost score threshold, C_{MAX} (840A), which may indicate a quantity of one or more resources allocated by a user for performing the QA process on the product. In some instances, R_{MIN} (850A) may also serve as a minimum quantity of risk to be mitigated (e.g., such as that which has been described above). In some implementations, the one or more thresholds may be used to isolate a specific group of subsets 860A. For example, in isolating group of subsets 860A, it may be determined that subsets of 870, 880, and 890 are not sufficient for QA. The particular subset that is ultimately selected may be one of the subsets contained in 860A. In some implementations, the subset ultimately selected from 860A may be the subset having the smallest quantity of items in subset 830 out of all subsets contained in 806A. As previously described, the one or more thresholds, which may be based on QA parameters, may vary as a function of time and creator. FIG. 8B illustrates an exemplary diagram 800B which demonstrates one or more objectives of optimization processes performed in association with FIGS. 1-8 above. For example, group of subsets 860A may be the only eligible group of subsets for all possible subsets as specified by QA parameters. One or more additional thresholds may be applied to 860A, such as a threshold along the axis of 830, in order to prioritize certain items. In some implementations, a user may prefer to have items with highest risk scores undergo QA processing. This sort of prioritization-by-risk may be made possible through minimization along the axis of 830. In some implementations, the cumulative risk score, cumulative cost score, and quantity of items in a subset are associated with various weights. For instance, a composite score may be determined based on a weighted cumulative risk score, weighted cumulative cost score, and a weighted quantity of items. Such weights may be included in QA parameters as described above. In these implementations, the particular subset selected may be one with a minimum or maximum composite score (which may depend on a weighting scheme applied). Weighting may allow the system to prioritize the characteristics when selecting a particular subset of items.

In some implementations, users may be allowed to test out different thresholds in a testing mode and review corresponding QA protocol results provided with such thresholds applied. For instance, a user may enter a risk tolerance threshold in the testing mode and subsequently be provided with information regarding an amount of time required to meet the threshold. In another example, the user may enter an amount of time to be allocated to QA processing (e.g., cost) and be provided with the maximum amount of risk that can be mitigated within such a time span. This mode may allow users of the system to better understand the capabilities of the QA management system and allow them to set appropriate thresholds and other QA parameters. The user inputs and outputs, as described above, may be enabled by one or more user interfaces associated with the QA management system. In some implementations, such outputs are included as information in QA protocols provided by the QA management system as described above.

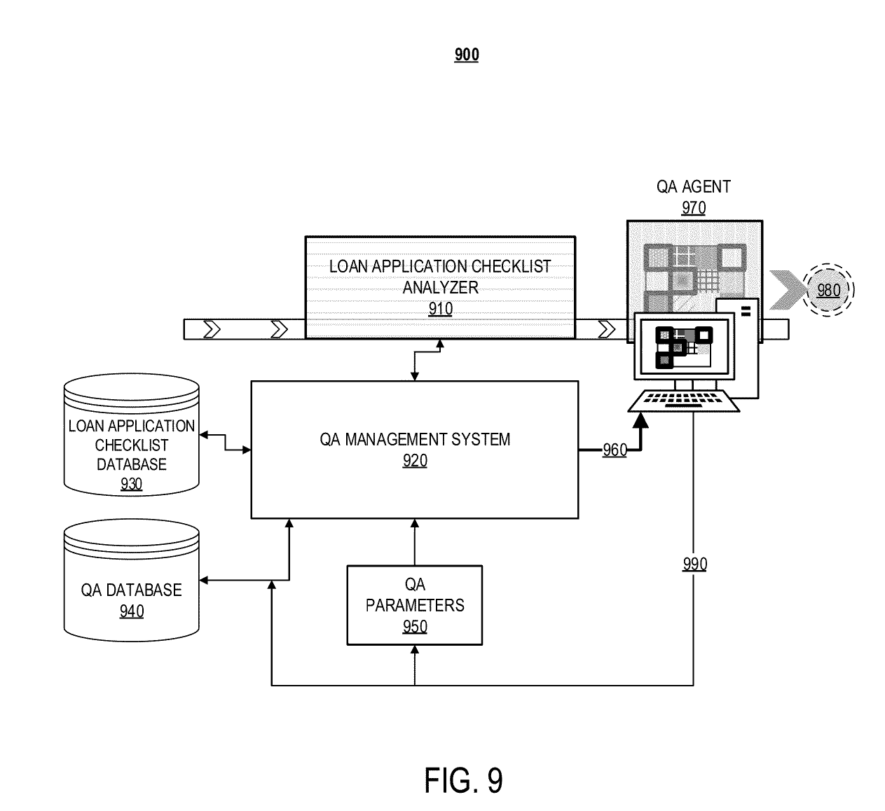

FIG. 9 illustrates an exemplary system 900 in which QA agent 970 provides processing data 990 to one or more of QA management system 920, checklist database 930, QA database 940, and QA parameters 950. Processing data 990 may indicate results of a QA process for a given item. For example, processing data 990 may indicate that a first item subjected to QA processing turned out to not contain any errors. Accordingly, processing data 990 may serve to update the occurrence information for the first item. Processing data 990 may also serve to indicate resource information, such as that which has been described above, that may be used to determine a cost score for the first item. For example, processing data 990 may indicate an amount of time taken by QA agent 970 to perform QA processing on the first item. In some implementations, processing data 990 may also indicate an availability of one or more resources. In this manner, a maximum cumulative cost score threshold, such as “C_{MAX}” described above, may be dynamically adjusted according to the availability of one or more resources as indicated by processing data 990. For example, if one or more resources become suddenly limited, processing data 990 may indicate this so that the QA management system 920 may be able to adapt its QA protocols 960 to conserve resources.

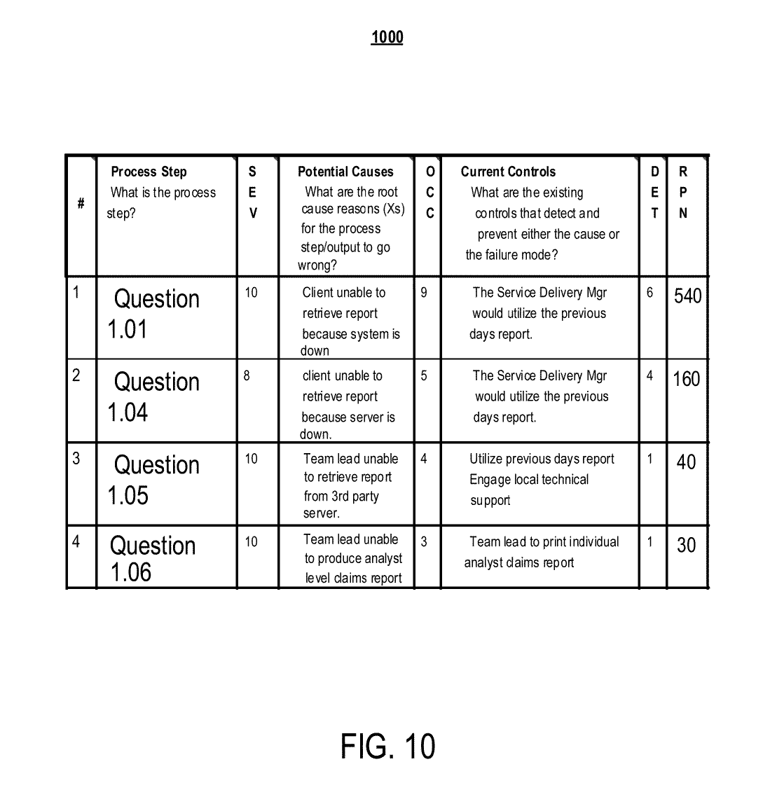

FIG. 10 illustrates an exemplary diagram 1000 of information which may be utilized by a system as depicted in FIGS. 1-6 to determine a risk score for a given item. In this implementation, each item is a checklist question from a loan application checklist. It can be see that each question 1.01-1.06 is associated with occurrence information “OCC”, severity information “SEV”, and detectability information “DET”. In some implementations, the risk score may be a risk priority number “RPN” based on OCC, SEV, and DET. In some instances, the RPN is calculated according to a failure mode and effects analysis. For example, the RPN may be a product of the OCC, SEV, and DET as shown in FIG. 10.

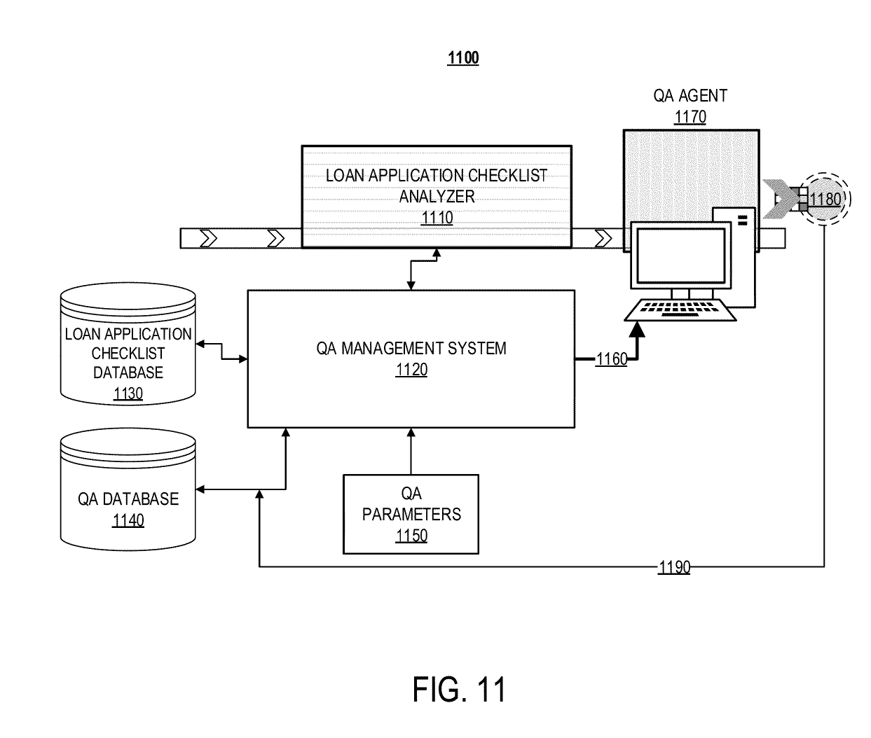

FIG. 11 illustrates an exemplary system 1100 in which a downstream destination 1180 provides post-QA data 1190 to one or more of QA management system 1120 and QA database 1140. In some implementations, severity information and detectability information is based at least in part on post-QA data 1190 from downstream destination 1180. For example, downstream destination 1180 may be another party responsible for performing additional handling or processing on products, a consumer, or other end-user. Detectability information may be adjusted in light of errors missed by one or more QA agents, such as QA agent 1170. Severity information may be adjusted in light of consequences experienced at downstream destination 1180 as a result of one or more errors. In this manner, post-QA data 1190 may be utilized in performing failure mode and effects analysis.

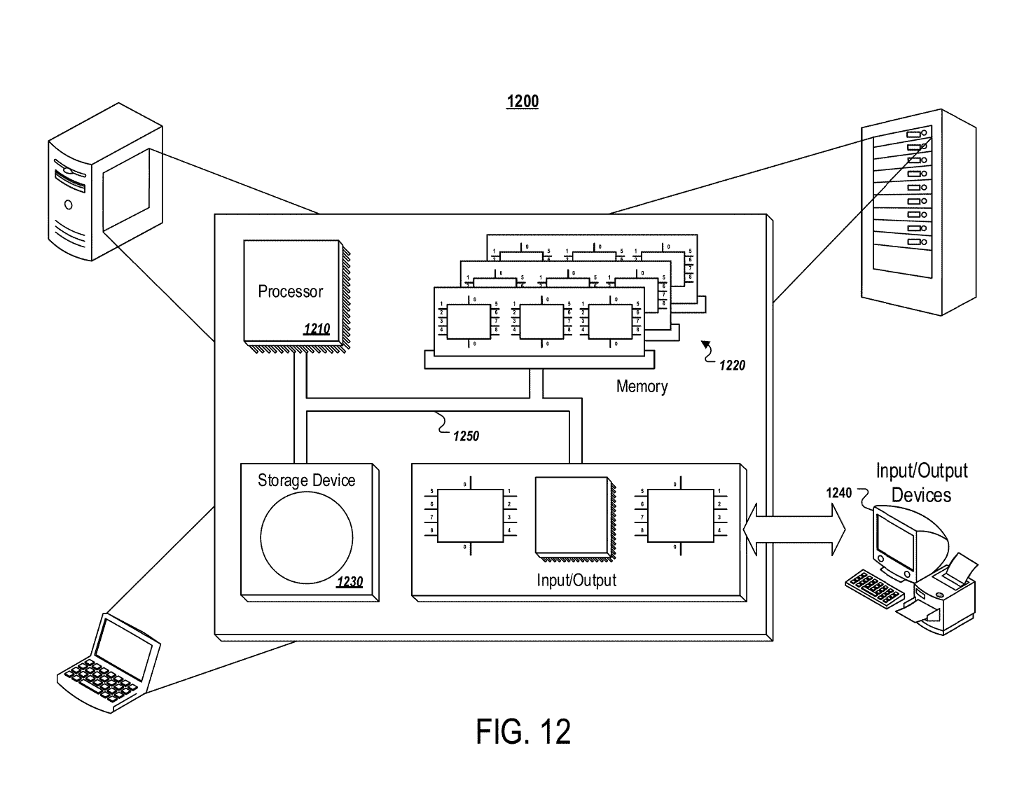

FIG. 12 is a schematic diagram of an example of a generic computer system 1200. The system 1200 can be used for the operations described in association with the processes 300 and 600 according to some implementations. The system 1200 may be included in the systems 100, 200, 400, 500, 900, and 1100.

The system 1200 includes a processor 1210, a memory 1220, a storage device 1230, and an input/output device 1240. Each of the components 1210, 1220, 1230, and 1240 are interconnected using a system bus 1250. The processor 1210 is capable of processing instructions for execution within the system 1200. In one implementation, the processor 1210 is a single-threaded processor. In another implementation, the processor 1210 is a multi-threaded processor. The processor 1210 is capable of processing instructions stored in the memory 1220 or on the storage device 1230 to display graphical information for a user interface on the input/output device 1240.

The memory 1220 stores information within the system 1200. In one implementation, the memory 1220 is a computer-readable medium. In one implementation, the memory 1220 is a volatile memory unit. In another implementation, the memory 1220 is a non-volatile memory unit.

The storage device 1230 is capable of providing mass storage for the system 1200. In one implementation, the storage device 1230 is a computer-readable medium. In various different implementations, the storage device 1230 may be a floppy disk device, a hard disk device, an optical disk device, or a tape device.

The input/output device 1240 provides input/output operations for the system 1200. In one implementation, the input/output device 1240 includes a keyboard and/or pointing device. In another implementation, the input/output device 1240 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method of adaptively managing quality assurance, the method comprising:
accessing quality assurance information associated with quality assurance for a loan application including a plurality of different items with a plurality of corresponding annotations for each of the plurality of different items;
accessing, for each item included in the quality assurance information, data that references a risk score indicating a level of risk associated with an uncorrected error in the annotation of the given item, and a cost score indicating a quantity of one or more resources required in order to perform quality assurance processing to reduce risk of uncorrected error in the annotation of the given item;
based at least on the data that references the risk score and the cost score for each of the plurality of different items, selecting, by at least one processor and from among the plurality of different items, a particular subset of items included in the quality assurance information, the selection including determining that the particular subset of items need quality assurance processing and determining that the plurality of different items not included the particular subset of items do not need quality assurance processing;
based on the particular subset of items, generating, by the at least one processor, instructions for performing a quality assurance process on each of the particular subset of items; and
sending, by the at least one processor, the instructions to one or more devices.

2. The computer-implemented method of claim 1, comprising:
determining a cumulative risk score for the loan application by summing the risk scores for every item;
determining that the cumulative risk score for the loan application exceeds a risk threshold by a first differential value; and
wherein selecting the particular subset of items based at least on the data that references the risk score and the cost score for each of the plurality of different items comprises selecting, based at least on determining that the cumulative risk score for the loan application exceeds the risk threshold, the particular subset of items.

3. The computer-implemented method of claim 2:
wherein the risk threshold is defined by a user; and
wherein determining that the cumulative risk score for the loan application exceeds the risk threshold by the first differential value comprises determining that the cumulative risk score for the loan application exceeds the user-defined risk threshold by the first differential value.

4. The computer-implemented method of claim 2, comprising:
determining a cumulative risk score for the particular subset of items by summing the risk scores for every item in the particular subset of items;
determining that the cumulative risk score for the particular subset of items is greater than or equal to the first differential value; and
wherein selecting the particular subset of items based at least on the data that references the risk score and the cost score for each of the plurality of different items comprises selecting, based at least on determining that the cumulative risk score for the particular subset of items is greater than or equal to the first differential value, the particular subset of items.

5. The computer-implemented method of claim 4, comprising:
determining a cumulative cost score for the particular subset of items by summing the cost scores for every item in the particular subset of items;
determining a quantity of items in the particular subset of items;
determining that the particular subset of items has one or more of a minimal cumulative cost score and a minimal quantity of items relative to other subsets of items; and
wherein selecting the particular subset of items based at least on the data that references the risk score and the cost score for each of the plurality of different items comprises selecting, based at least on determining that the particular subset of items has one or more of a minimal cumulative cost score and a minimal quantity of items relative to other subsets of items, the particular subset of items.

6. The computer-implemented method of claim 1:
wherein the risk score for each item is based at least on a level of creator occurrence associated with error in the annotations of the given items, and wherein the level of creator occurrence references a historical rate of error in the annotation of the given item for a particular creator of the annotations; and
wherein selecting the particular subset of items based at least on the data that references the risk score and the cost score for each of the plurality of different items comprises selecting, based at least on the particular creator's historical rate of error in the annotation of the given item of the loan application, the particular subset of items.

7. The computer-implemented method of claim 6:
wherein the risk score for each item is further based on one or more of a general level of occurrence for creators across a plurality of loan applications, a level of severity, and a level of detectability associated with uncorrected error in the annotation of the given item; and
wherein selecting the particular subset of items based at least on the data that references the risk score and the cost score for each of the plurality of different items comprises selecting, based at least on one or more of the general level of occurrence for creators across the plurality of loan applications, the level of severity, and the level of detectability associated with uncorrected error in the annotation of the each item of the loan application, the particular subset of items.

8. The computer-implemented method of claim 7, wherein the level of detectability associated with uncorrected error in the annotation of the given item on which the risk score for each item is based, is reflective of a degree of difficulty in discovering error in the annotation of the given item at a point downstream from the quality assurance process; and
wherein the risk score for each item is based on the level of detectability associated with uncorrected error in the annotation of the given item.

9. The computer-implemented method of claim 1, wherein the one or more resources required in order to perform the quality assurance processing to reduce risk of uncorrected error in the annotation of the given item comprise one or more of a quantity of time, a quantity of funds, and a quantity of quality assurance agents.

10. The computer-implemented method of claim 1, comprising:
evaluating, for each of a plurality of different subsets of items, at least the risk score and cost score for each item in the given subset of items; and
wherein selecting the particular subset of items based at least on the data that references the risk score and the cost score for each of the plurality of different items comprises selecting, based at least on evaluation results, the particular subset of items from among the plurality of different subsets of items.

11. The computer-implemented method of claim 1:
before accessing the risk score and cost score, performing a failure mode and effects analysis which includes determining a risk priority number for each item of the loan application.

12. The computer-implemented method of claim 11:
wherein the risk score for each item of the loan application is based at least on its corresponding risk priority number; and
wherein accessing, for each item of the loan application, data that references the risk score indicating the level of risk associated with uncorrected error in the annotation of the given item comprises accessing, for each item of the loan application, data that references the risk score based on the corresponding risk priority number of the given item and indicating the level of risk associated with uncorrected error in the annotation of the given item.

13. The computer-implemented method of claim 1:
wherein the loan application is associated with a particular creator from among a plurality of creators, the particular creator being responsible for annotating each item of the loan application; and
wherein selecting the particular subset of items based at least on the data that references the risk score and the cost score for each of the plurality of different items comprises selecting, based at least on the particular creator associated with the loan application, the particular subset of items.

14. The computer-implemented method of claim 1, wherein the one or more devices comprise one or more quality assurance agents configured to perform the quality assurance process on the loan application according to the instructions.

15. The computer-implemented method of claim 14, wherein performing the quality assurance process on the loan application comprises performing, for each item in the particular subset of items, the quality assurance processing to reduce risk of uncorrected error in the annotation of the given item.

16. The computer-implemented method of claim 14, further comprising:
receiving data that references results of the quality assurance process; and
based on the results of the quality assurance process, updating the data that references the risk score and the data that references the cost score.

17. The computer-implemented method of claim 1:
wherein the quality assurance information associated with quality assurance for the loan application including the plurality of different items with the plurality of corresponding annotations for each of the plurality of different items, includes creator information indicating the creator responsible for annotating each item of the loan application and information that references an item type for each item of the loan application; and
wherein accessing, for each item of the loan application, data that references the risk score and cost score comprises retrieving, based on the creator information and the information that references the item type for each item of the loan application, data that references the risk score and cost score for each item of the loan application.

18. The computer-implemented method of claim 1, comprising:
determining a cumulative cost score for the particular subset of items by summing the cost scores for every loan application item in the particular subset of items;
determining that the cumulative cost score for the particular subset of items is less than or equal to a cost threshold indicating a quantity of one or more resources allocated by a user for performing the quality assurance process on the loan application; and
wherein selecting the particular subset of items based at least on the data that references the risk score and the cost score for each of the plurality of different items comprises selecting, based at least on determining that the cumulative cost score for the particular subset of items is less than or equal to the cost threshold indicating the quantity of one or more resources allocated by the user for performing the quality assurance process on the loan application, the particular subset of items.

19. An adaptive quality assurance management system comprising:
at least one processor; and
at least one memory coupled to the at least one processor having stored thereon instructions which, when executed by the at least one processor, causes the at least one processor to perform operations comprising:
accessing quality assurance information associated with quality assurance for a loan application including a plurality of different items with a plurality of corresponding annotations for each of the plurality of different items;
accessing, for each item included in the quality assurance information, data that references a risk score indicating a level of risk associated with an uncorrected error in the annotation of the given item, and a cost score indicating a quantity of one or more resources required in order to perform quality assurance processing to reduce risk of uncorrected error in the annotation of the given item;
based at least on the data that references the risk score and the cost score for each of the plurality of different items, selecting, by at least one processor and from among the plurality of different items, a particular subset of items included in the quality assurance information, the selection including determining that the particular subset of items need quality assurance processing and determining that the plurality of different items not included the particular subset of items do not need quality assurance processing;
based on the particular subset of items, generating instructions for performing a quality assurance process on each of the particular subset of items; and
sending the instructions to one or more devices.

20. At least one computer-readable storage medium encoded with executable instructions that, when executed by at least one processor, cause the at least one processor to perform operations comprising:
accessing quality assurance information associated with quality assurance for a loan application including a plurality of different items with a plurality of corresponding annotations for each of the plurality of different items;
accessing, for each item included in the quality assurance information, data that references a risk score indicating a level of risk associated with an uncorrected error in the annotation of the given item, and a cost score indicating a quantity of one or more resources required in order to perform quality assurance processing to reduce risk of uncorrected error in the annotation of the given item;
based at least on the data that references the risk score and the cost score for each of the plurality of different items, selecting, by at least one processor and from among the plurality of different items, a particular subset of items included in the quality assurance information, the selection including determining that the particular subset of items need quality assurance processing and determining that the plurality of different items not included the particular subset of items do not need quality assurance processing;
based on the particular subset of items, generating instructions for performing a quality assurance process on each of the particular subset of items; and
sending the instructions to one or more devices.
